(19) United States
(12) Patent Application Publication
(10) Pub. No.: US 2026/0246631 A1
(43) Pub. Date: Aug. 20, 2026

(54) INFORMATION UPDATING DEVICE AND METHOD, AND AUTHENTICATION DEVICE

(71) Applicant: NEC Corporation, Tokyo (JP)

(72) Inventors: Kazuki INAGAKI, Tokyo (JP); Toshiyuki ISSHIKI, Tokyo (JP); Kengo MORI, Tokyo (JP); Yuta SHIMIZU, Tokyo (JP); Koyo SHIBATA, Tokyo (JP); Kohei HIJIKATA, Tokyo (JP)

(73) Assignee: NEC Corporation, Tokyo (JP)

(21) Appl. No.: 19/161,803

(22) PCT Filed: Mar. 15, 2023
(86) PCT No.: PCT/JP2023/010021

§ 371 Date: Sep. 3, 2025

(51) Int. Cl. H04L 9/08; H04L 9/32

(52) U.S. Cl. CPC H04L 9/0891; H04L 9/3231

(57) ABSTRACT

Making it possible to update key information that is used for encryption at an appropriate timing. A biometric information acquisition unit (11) acquires biometric information of a user. An encryption unit (12) encrypts the acquired biometric information with cryptographic key information, and generates query biometric information. An authentication unit (13) authenticates the user by comparing the query biometric information and target biometric information encrypted using the cryptographic key information. A comparison unit (15) compares a comparison score in the authentication with a predetermined threshold value. An information update unit (16) updates the cryptographic key information and the target biometric information if the comparison score is smaller than the predetermined threshold value.

### TECHNICAL FIELD

The present disclosure relates to an information updating device, an information updating method, an authentication device, an authentication method, and a computer-readable medium.

### BACKGROUND ART

As a related art, PTL 1 discloses a biometric authentication system. In the biometric authentication system described in PTL 1, a registration terminal reads fingerprints of a user and transmits read fingerprint information to a registration authentication server. The registration authentication server receives the fingerprint information and creates a template. The registration authentication server randomly generates an encryption key and saves user key data including a user ID and the generated encryption key, in a storage device. Next, the registration authentication server encrypts the template using the generated encryption key and transmits authentication information including the user ID and the encrypted template to the registration terminal. The registration terminal receives the authentication information, two-dimensionally codes the authentication information, and prints the two-dimensionally coded authentication information on an ID card.

In a case where authentication is implemented, the user presents the two-dimensional code of the ID card to an authentication terminal. The authentication terminal reads the two-dimensional code presented by the user and transmits authentication information of the read two-dimensional code to the registration authentication server. The authentication terminal reads the fingerprints of the user and transmits the read fingerprint information to the registration authentication server. The registration authentication server searches for the user key data by using the user ID included in the authentication information and acquires the encryption key used for encryption of the template. The registration authentication server decrypts the encrypted template included in the authentication information, by using the acquired encryption key.

In a case where the encrypted template is successfully decrypted, the registration authentication server verifies the decrypted template against the template generated from the fingerprint information. In a case where the verification is successful, the registration authentication server randomly generates a new encryption key and rewrites the encryption key included in the user key data with the newly generated encryption key. The registration authentication server encrypts the template using the new encryption key and transmits authentication information including the encrypted template and the user ID to the authentication terminal. The authentication terminal two-dimensional codes the received authentication information. The authentication terminal erases the two-dimensional code already printed on the ID card and prints the newly generated two-dimensional code on the ID card.

### CITATION LIST

### Patent Literature

PTL 1: JP 2005-293490 A

### SUMMARY OF INVENTION

### Technical Problem

In PTL 1, an authentication registration server generates a new encryption key, only in a case where user authentication is successful. An authentication terminal rewrites a two-dimensional code indicating authentication information to be printed, with a two-dimensional code indicating authentication information encrypted using the new encryption key. In this case, the user can always have a template encrypted using the new encryption key. Therefore, an ID card forged by copying in the past is invalidated, and it is possible to reduce a risk that the forged ID card is used.

However, in PTL 1, there is a problem in that the encryption key is frequently updated, because the encryption key is generated each time authentication is successful. In view of this problem, in a case where the encryption key is updated if it is found that the ID card is forged, instead of updating the encryption key each time the authentication is successful, it is possible to invalidate the forged ID card, while reducing a frequency of the update of the encryption key. However, in general, it is not possible for the user to accurately know in time the ID card is forged. During a period from a moment the user notices the counterfeit until the encryption key and the two-dimensional code are updated, the forged ID card is valid, and impersonation using the forged ID card is possible. Therefore, changing the encryption key at an appropriate timing is considered to be preferable.

In view of the above circumstances, an object of the present disclosure is to provide an information updating device, an information updating method, an authentication device, an authentication method, and a computer-readable medium capable of updating key information used for encryption at an appropriate timing.

### Solution to Problem

In order to achieve the above object, the present disclosure provides, as a first aspect, an information updating device. An information updating device includes a comparison unit that compares a verification score indicating a similarity degree between query biometric information and target biometric information, calculated in authentication implemented by verifying the query biometric information generated by encrypting biometric information of a user using encryption key information against the target biometric information encrypted using the encryption key information, with a first threshold, and an information updating unit that updates the encryption key information, in a case where the verification score is smaller than the first threshold and updates the target biometric information using the updated encryption key information.

The present disclosure provides, as a second aspect, an authentication device. An authentication device includes a biometric information acquisition unit that acquires biometric information of a user, an encryption unit that encrypts the acquired biometric information using encryption key information and generates query biometric information, an authentication unit that verifies the query biometric information against target biometric information encrypted using the encryption key information and authenticates the user, based on a verification score indicating a similarity degree between the query biometric information and the target biometric information, a comparison unit that compares the verification score with a first threshold, and an information updating unit that updates the encryption key information, in a case where the verification score is smaller than the first threshold and updates the target biometric information using the updated encryption key information.

The present disclosure provides, as a third aspect, an information updating method. An information updating method includes comparing a verification score indicating a similarity degree between query biometric information and target biometric information, calculated in authentication implemented by verifying the query biometric information generated by encrypting biometric information of a user using encryption key information against the target biometric information encrypted using the encryption key information, with a predetermined threshold and updating the encryption key information, in a case where the verification score is smaller than the predetermined threshold and updating the target biometric information using the updated encryption key information.

The present disclosure provides, as a fourth aspect, an authentication method. An authentication method includes acquiring biometric information of a user, encrypting the acquired biometric information using encryption key information and generating query biometric information, verifying the query biometric information against target biometric information encrypted using the encryption key information and authenticating the user, based on a verification score indicating a similarity degree between the query biometric information and the target biometric information, comparing the verification score with a predetermined threshold, and updating the encryption key information, in a case where the verification score is smaller than the predetermined threshold and updating the target biometric information using the updated encryption key information.

The present disclosure provides, as a fifth aspect, a computer-readable medium. A computer-readable medium stores a program for causing a processor to execute processing including comparing a verification score indicating a similarity degree between query biometric information and target biometric information, calculated in authentication implemented by verifying the query biometric information generated by encrypting biometric information of a user using encryption key information against the target biometric information encrypted using the encryption key information, with a predetermined threshold and updating the encryption key information, in a case where the verification score is smaller than the predetermined threshold and updating the target biometric information using the updated encryption key information.

The present disclosure provides a computer-readable medium as a sixth aspect. A computer-readable medium stores a program for causing a processor to execute processing including acquiring biometric information of a user, encrypting the acquired biometric information using encryption key information and generating query biometric information, verifying the query biometric information against target biometric information encrypted using the encryption key information and authenticating the user, based on a verification score indicating a similarity degree between the query biometric information and the target biometric information, comparing the verification score with a predetermined threshold, and updating the encryption key information, in a case where the verification score is smaller than the predetermined threshold and updating the target biometric information using the updated encryption key information.

### Advantageous Effects of Invention

An update notification device, an authentication device, an update notification method, an authentication method, and a computer-readable medium according to the present disclosure can update key information used for encryption at an appropriate timing.

### BRIEF DESCRIPTION OF DRAWINGS

FIG. 1 is a block diagram illustrating a schematic configuration of an authentication device according to the present disclosure.

FIG. 2 is a block diagram illustrating an authentication system including an authentication device according to a first example embodiment of the present disclosure.

FIG. 3 is a schematic diagram illustrating biometric information extracted from a camera image, query biometric information, and target biometric information.

FIG. 4 is a graph illustrating a verification score calculated by a plurality of times of face authentication.

FIG. 5 is a flowchart illustrating an operation procedure at the time of authentication in the authentication device.

FIG. 6 is a block diagram illustrating an authentication system including an authentication device according to a second example embodiment of the present disclosure.

FIG. 7 is a block diagram illustrating a configuration example of an electronic device.

### EXAMPLE EMBODIMENT

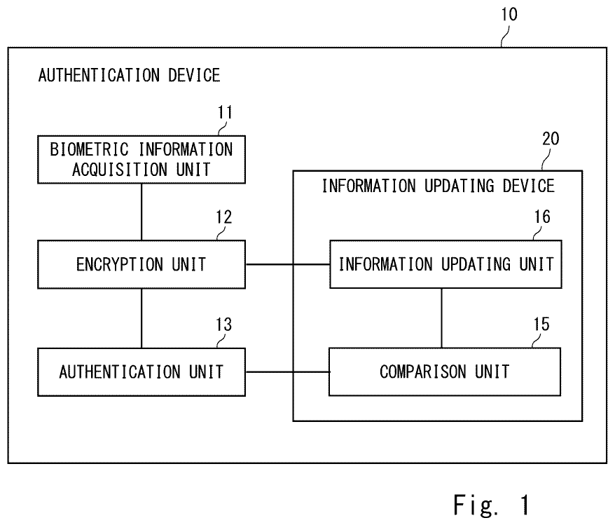

Prior to describing example embodiments of the present disclosure, an overview of the present disclosure will be given. FIG. 1 illustrates a schematic configuration of an authentication device according to the present disclosure. An authentication device 10 includes a biometric information acquisition unit 11, an encryption unit 12, an authentication unit 13, a comparison unit 15, and an information updating unit 16. In the authentication device 10, the comparison unit 15 and the information updating unit 16 configure an information updating device 20.

FIG. 1 illustrates an example in which the information updating device 20 is included in the authentication device 10, but the present disclosure is not limited thereto. The information updating device 20 is not necessarily included in the authentication device 10, and the authentication device 10 and the information updating device 20 may be configured as independent devices.

The biometric information acquisition unit 11 acquires biometric information about a user. The encryption unit 12 encrypts the biometric information acquired by the biometric information acquisition unit 11 with encryption key information to generate query biometric information. The authentication unit 13 verifies the query biometric information against target biometric information encrypted with the encryption key information used by the encryption unit 12 and calculates a verification score indicating a similarity degree between the query biometric information and the target biometric information. The authentication unit 13 determines whether authentication is successful, based on the verification score.

The comparison unit 15 compares the verification score calculated by verifying the query biometric information against the target biometric information with a predetermined threshold. In a case where the verification score is lower than the predetermined threshold, the information updating unit 16 updates the encryption key information used for encryption by the encryption unit 12. The information updating unit 16 updates the target biometric information by using the updated encryption key information.

In the present disclosure, in a case where the verification score in biometric authentication is low, the information updating unit 16 updates the encryption key information used for the encryption and the target biometric information. For example, in a case where a malicious person impersonates the user and tries to pass face authentication, the verification score is considered to be low. In the present disclosure, for example, if a suspicious person performs face authentication on the authentication device 10, the encryption key information and the registered target biometric information can be updated. Therefore, the authentication device 10 and the information updating device 20 according to the present disclosure can update key information used for encryption at an appropriate timing. In the present disclosure, a security risk can be reduced by updating the key information used for encryption and the target biometric information at an appropriate timing. The present disclosure has an effect that the number of times of updating the encryption key information can be reduced as compared with that in a case where the key information is updated every time in a case where the authentication has been successful.

Hereinafter, the example embodiments of the present disclosure will be described in detail with reference to the drawings. The following description and drawings will be omitted or simplified as appropriate to clarify description. In each of the drawings described below, the same elements and similar elements are denoted by the same reference signs, and a duplicate description is omitted as necessary.

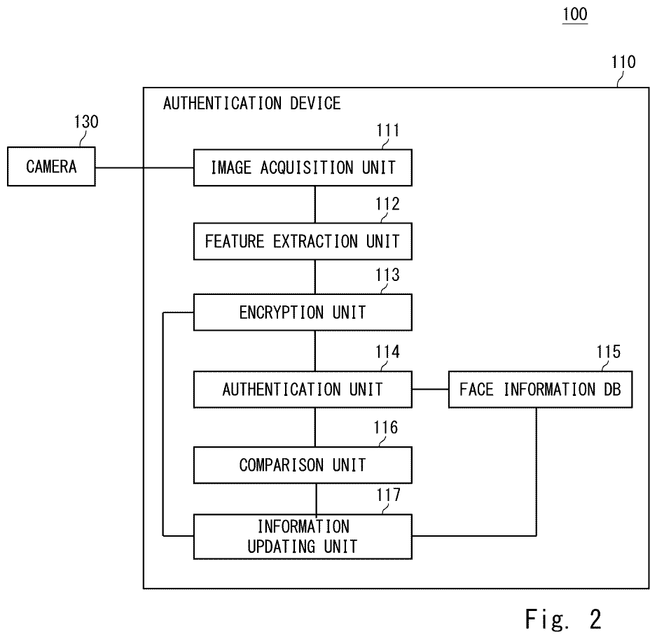

FIG. 2 illustrates an authentication system including the authentication device according to a first example embodiment of the present disclosure. An authentication system 100 includes the authentication device 110 and a camera 130. In the following description, an example in which the authentication system 100 is used for a vehicle interior entry in a vehicle such as an automobile will be described. The authentication system 100 is not limited to the vehicle interior entry, and may be applied to authentication in various systems such as an access management system to a specific location or area.

The camera 130 captures an image of a user to be authenticated or a subject. In the present example embodiment, the camera 130 captures an image of a person who is trying to get on the vehicle. The vehicle is, for example, a moving object such as a passenger car, a taxi, or a van. The camera 130 is mounted on a vehicle, for example, and captures an image of the user outside the vehicle from an inside of the vehicle. The camera 130 may be installed outside the vehicle and capture an image of the user approaching the vehicle. Alternatively, the camera 130 may be installed in the vehicle and capture an image of the user in the vehicle. The authentication device 110 acquires the image of the user from the camera 130, and implements biometric authentication on the user using the acquired image.

Although only one camera 130 is illustrated in FIG. 2, the number of cameras 130 is not limited to one in the present example embodiment. The authentication system 100 may have the plurality of cameras 130. The authentication system 100 can include, for example, one or more cameras that capture an image of the vehicle from the outside of the vehicle, one or more cameras that are mounted on the vehicle and capture an image of a region outside the vehicle, and one or more cameras that are mounted on the vehicle and capture an image of a region in the vehicle.

The authentication device 110 includes an image acquisition unit 111, a feature extraction unit 112, an encryption unit 113, an authentication unit 114, a face information database (DB) 115, a comparison unit 116, and an information updating unit 117. The authentication device 110 can be configured as, for example, a device including one or more memories and one or more processors. At least a part of the function of each unit in the authentication device 110 may be achieved by the processor operating according to a program read from the memory. The authentication device 110 may be mounted on the vehicle, for example. The authentication device 110 is associated with the authentication device 10 illustrated in FIG. 1.

The image acquisition unit 111 acquires a video or an image captured by the camera 130. The image acquisition unit 111 sequentially acquires the latest image captured by the camera 130. The feature extraction unit 112 extracts a biometric feature from the image acquired by the image acquisition unit 111. The biometric feature is also referred to as biometric information. For example, the feature extraction unit 112 detects a face region or a face image of a person existing around the vehicle, that is, the user from the image data, and extracts biometric information from the detected face region or face image. The feature extraction unit 112 is associated with the biometric information acquisition unit 11 illustrated in FIG. 1.

The encryption unit 113 encrypts the biometric information extracted by the feature extraction unit 112 using the encryption key information to generate encrypted biometric information. In the present example embodiment, it is assumed that homomorphic encryption be used as an encryption scheme. The encrypted biometric information is also referred to as the query biometric information. The encryption unit 113 is associated with the encryption unit 12 illustrated in FIG. 1.

The face information DB 115 stores the biometric information extracted from the face image for each of one or more registrants to be authenticated, that is, each of the users. The face information DB 115 stores the biometric information of each of the plurality of users, for example, in a storage such as a Hard Disk Drive (HDD), a Solid State Drive (SSD), or a flash memory. The biometric information stored in the face information DB 115 is also referred to as the target biometric information. In the present example embodiment, the target biometric information stored in the face information DB 115 is encrypted using the encryption key information used for encryption by the encryption unit 113.

For example, the user registers the biometric information in the authentication device 110 in advance. In a case of registering the biometric information, the user inputs, for example, a camera image captured by his/her smartphone or digital camera to the authentication device 110. The authentication device 110 extracts the biometric information from the camera image input by the user in the feature extraction unit 112, and encrypts the biometric information extracted in the encryption unit 113 using the encryption key information. The authentication device 110 stores the encrypted biometric information in the face information DB 115 as the target biometric information. The face information DB 115 may store an encrypted face image of each of one or more users instead of or in addition to the encrypted biometric information.

In the present example embodiment, the face information DB 115 is not necessarily included in the authentication device 10. The face information DB 115 may be configured using, for example, a storage device connected to the authentication device 10 via a network.

The authentication unit 114 verifies the query biometric information encrypted by the feature extraction unit 112 against the target biometric information stored in the face information DB 115 to authenticate the user. More specifically, the authentication unit 114 acquires the target biometric information about each user from the face information DB 115. The authentication unit 114 verifies the query biometric information against the acquired target biometric information about each user. The authentication unit 114 calculates a verification score indicating a matching degree or a similarity degree between the query biometric information and the target biometric information, in the verification. It is assumed that the verification score indicates a higher value as the matching degree or the similarity degree is higher, for example. For example, the authentication unit 114 compares the verification score calculated for each user with a determination threshold, and determines whether the face authentication is successful based on a result of the comparison. The authentication unit 114 is associated with the authentication unit 13 illustrated in FIG. 1.

The authentication result of the authentication device 110 is output to a device or system that uses the authentication result, such as a vehicle interior entry system. For example, the authentication device 110 outputs the authentication result to vehicle equipment (not illustrated) such as an Electronic Control Unit (ECU) that controls the vehicle through an in-vehicle network such as a Controller Area Network (CAN). If the person included in the camera image is authenticated as the user registered in advance, the ECU unlocks doors of the vehicle and permits the user to get on the vehicle. If the person included in the camera image is not authenticated as the user registered in advance, the ECU does not unlock the doors of the vehicle.

The comparison unit 116 compares the verification score with a predetermined threshold (first threshold). The first threshold is, for example, equal to the determination threshold (second threshold) used to determine whether the authentication by the authentication unit 114 is successful or fails. Alternatively, the first threshold may be smaller than the second threshold. The first threshold does not necessarily need to be equal to or less than the second threshold and may be larger than the second threshold. The comparison unit 116 determines whether the verification score is smaller than the first threshold. In a case where the authentication unit 114 calculates the verification score with the plurality of pieces of target biometric information, the comparison unit 116 may determine whether a maximum value of the verification score is smaller than the first threshold. The comparison unit 116 is associated with the comparison unit 15 illustrated in FIG. 1.

In a case where it is determined that the verification score is smaller than the first threshold, as a result of the comparison by the comparison unit 116, the information updating unit 117 changes or updates the encryption key information used for generating the query biometric information in the encryption unit 113. The information updating unit 117 updates the target biometric information stored in the face information DB 115 using the changed or updated encryption key information. The information updating unit 117 may update the encryption key information and the target biometric information, each time the verification score is determined to be smaller than the first threshold. Alternatively, the information updating unit 117 counts the number of times the verification score is determined to be smaller than the first threshold, and in a case where the counted number reaches a predetermined number of times, the information updating unit 117 may update the encryption key information and the target biometric information. The information updating unit 117 is associated with the information updating unit 16 illustrated in FIG. 1.

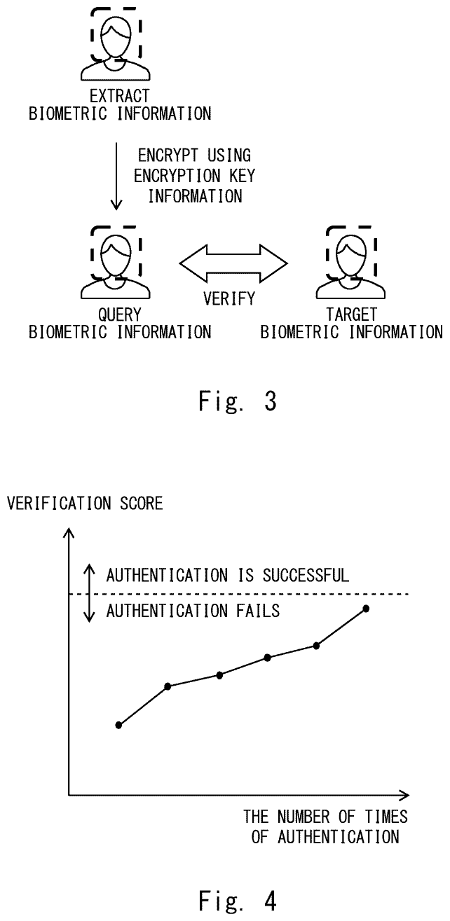

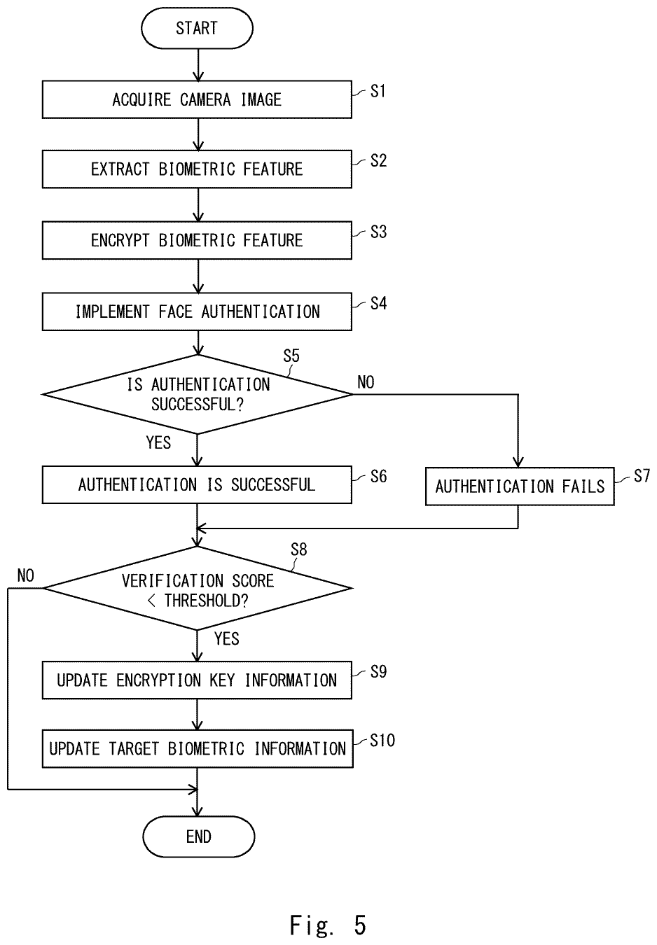

FIG. 3 illustrates the biometric information extracted from the camera image, the query biometric information, and the target biometric information. The feature extraction unit 112 extracts the biometric information from the camera image. The encryption unit 113 encrypts the biometric information extracted by the feature extraction unit 112 using the encryption key information and generates the query biometric information. The authentication unit 114 verifies the query biometric information encrypted by the encryption unit 113 against the encrypted target biometric information stored in the face information DB 115.

In a case where the comparison unit 116 determines that the verification score is smaller than the first threshold, the information updating unit 117 updates the encryption key information and the target biometric information stored in the face information DB 115. In a case where the encryption key information is updated, the query biometric information and the target biometric information before the encryption key information is updated are different from the query biometric information and the target biometric information after the encryption key information is updated. Therefore, even if the target biometric information is stolen by a malicious person, the stolen target biometric information can be invalidated by changing the encryption key information. Therefore, the present example embodiment can reduce a risk in a case where personal information leaks and improve security.

In the present example embodiment, the authentication unit 114 may store the verification score calculated in the face authentication, in a storage device (not illustrated) as history information, each time the face authentication is implemented. The information updating unit 117 may refer to the history information of the verification score and update the encryption key information and the target biometric information using the verification score calculated by the plurality of times of face authentication in the past. For example, in a case where the number of times that the verification score calculated in the plurality of face authentication in the past is determined to be smaller than the first threshold is equal to or more than a predetermined number of times and the verification score tends to increase, the information updating unit 117 may update the encryption key information and the target biometric information.

FIG. 4 illustrates the verification score calculated by the plurality of times of face authentication. In the graph illustrated in FIG. 4, the horizontal axis indicates the number of times of face authentication, and the vertical axis indicates the verification score. In an attack on the face authentication, an attack is considered in which an attacker gradually brings one's face to a face of an authorized user by disguising or the like, in the plurality of times of face authentication, and passes the face authentication. In a case of such an attack, it is considered that, although the verification score is low at the beginning, the verification score gradually increases and approaches the determination threshold (second threshold) to be a boundary between authentication success/authentication failure. In a case where the face authentication fails and the verification score tends to increase in the plurality of times of authentication in the past, it is considered that the security risk can be reduced, by updating the encryption key information and target information.

Next, an operation procedure will be described. FIG. 4 illustrates an operation procedure at the time of authentication in the authentication device 110. The operation procedure of the authentication device 110 is associated with an authentication method. The image acquisition unit 111 acquires the camera image from the camera 130 (step S1). The image acquisition unit 111 may periodically perform step S1 and acquire the camera images in time series from the camera 130 that captures a moving image. The feature extraction unit 112 detects a face region from the camera image and extracts a biometric feature from the image of the face region (step S2). In step S2, for example, the feature extraction unit 112 extracts one or more feature points from the image of the face region, and extracts one or more biometric features based on the extracted one or more feature points.

The encryption unit 113 encrypts the biometric feature extracted in step S2 and generates query biometric information (step S3). The authentication unit 114 verifies the query biometric information generated in step S3 against the target biometric information stored in the face information DB 115, and implements face authentication (step S4). In step S4, the authentication unit 114 calculates a verification score with the query biometric information for the target biometric information.

The authentication unit 114 determines whether the face authentication is successful (step S5). In step S5, for example, the authentication unit 114 compares the verification score with the determination threshold, and determines whether the face authentication is successful, according to whether the verification score is equal to or more than the determination threshold. In a case where the verification score is equal to or more than the determination threshold, the authentication unit 114 determines that the face authentication is successful in step S5. In this case, the authentication unit 114 outputs a message indicating that the face authentication is successful to a device that uses the authentication result, such as the vehicle interior entry system (step S6).

In a case where the verification score is smaller than the determination threshold, the authentication unit 114 determines that the face authentication has failed in step S5. In this case, the authentication unit 114 outputs a message indicating that the face authentication has failed to the device using the authentication result (step S7).

The comparison unit 116 determines whether the verification score is smaller than the predetermined threshold (first threshold) (step S8). In a case where the first threshold is equal to the determination threshold (second threshold), and in a case where the authentication has failed, it is determined in step S8 that the verification score is smaller than the first threshold. In a case where the first threshold is smaller than the second threshold, and in a case where the authentication has failed and the verification score is lower than the second threshold by a predetermined value or more, it is determined in step S8 that the verification score is smaller than the first threshold. In a case where the first threshold is higher than the second threshold, and in a case where the verification score is relatively low although the authentication is successful, it is determined in step S8 that the verification score is smaller than the first threshold.

In a case of determining that the verification score is smaller than the first threshold, the comparison unit 116 transmits a notification indicating that the verification score is low, to the information updating unit 117. The comparison unit 116 counts the number of times the verification score is determined to be lower than the first threshold, and in a case where the number of times reaches a predetermined number of times, the comparison unit 116 may transmit the notification indicating that the verification score is low, to the information updating unit 117.

In a case where the comparison unit 116 determines that the verification score is smaller than the first threshold, the information updating unit 117 updates the encryption key information used to encrypt the biometric information by the encryption unit 113, that is, the encryption key information used to generate the query biometric information (step S9). In step S9, the information updating unit 117 generates encryption key information different from the encryption key information used for encryption by the encryption unit 113, and transmits the generated encryption key information to the encryption unit 113. In a case of receiving the encryption key information from the information updating unit 117, the encryption unit 113 changes the encryption key information used for encryption to the encryption key information received from the information updating unit 117.

The information updating unit 117 updates the target biometric information stored in the face information DB 115 using the updated encryption key information (step S10). In step S10, the information updating unit 117 updates the target biometric information, for example, by decrypting the target biometric information before update using the key information before update and encrypting the decrypted target biometric information using the updated encryption key information. The operations in steps S8 to S10 are associated with an information updating method.

In the present example embodiment, in a case where the comparison unit 116 determines that the verification score is smaller than the first threshold, the information updating unit 117 updates the encryption key information and the target biometric information. In a case where the information updating unit 117 updates the encryption key information, the target biometric information encrypted with the old encryption key information cannot be used for authentication. Therefore, the present example embodiment can improve security. In the present example embodiment, if the verification score is determined to be low, the encryption key information and the target biometric information are updated. Therefore, even in a case where the user does not particularly instruct to update the encryption key information, in a case where impersonation for face authentication is suspected, the encryption key information is updated. In the present example embodiment, even if target biometric information is stolen, a period during which the stolen target biometric information can be used for authentication can be shortened, and a possibility that the stolen target biometric information is abused can be reduced.

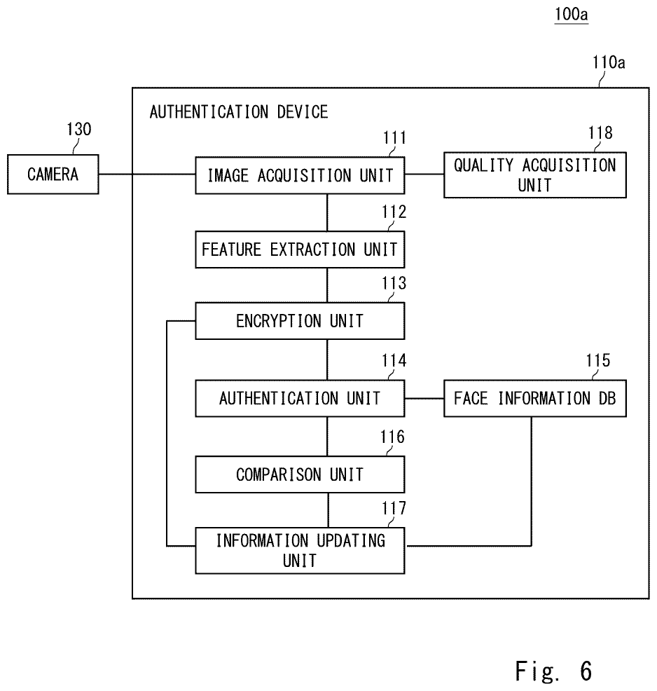

Next, a second example embodiment of the present disclosure will be described. FIG. 6 illustrates an authentication system according to the second example embodiment of the present disclosure. In an authentication system 100a according to the present example embodiment, an authentication device 110a includes a quality acquisition unit 118, in addition to the configuration of the authentication device 110 described in the first example embodiment illustrated in FIG. 2.

The quality acquisition unit 118 acquires quality of biometric information of a user used for biometric authentication. In the present example embodiment, the quality acquisition unit 118 acquires quality of an image acquired from a camera 130, that is, a face image used for face authentication. The quality of the face image indicates, for example, a degree at which the image is suitable for the face authentication. The quality acquisition unit 118 includes, for example, an Artificial Intelligence (AI) engine that determines how much the image is suitable for the face authentication. The quality acquisition unit 118 inputs the image acquired by the image acquisition unit 111 into the AI engine and acquires the quality of the face image.

For example, in a case where an authentication unit 114 fails in the face authentication, a factor of the failure in the face authentication can be determined, according to the quality of the face image. For example, in a case where the quality of the face image is lower than predetermined quality, that is, the face image is not an image suitable for the face authentication, there is a possibility that the face authentication fails due to an environment such as lighting or a light environment. On the other hand, in a case where the quality of the face image is high, that is, the face image is the image suitable for the face authentication, in a case where the face authentication fails, there is a possibility that the face authentication fails because the image is a face image of a person who is not a user.

In the present example embodiment, in a case where a verification score is smaller than a first threshold, an information updating unit 117 may determine whether encryption key information and target biometric information are updated, according to the quality of the face image acquired by the quality acquisition unit 118. For example, in a case where the quality of the face image is equal to or higher than the predetermined quality, the information updating unit 117 determines that the face authentication fails because the person who is not the user tries to implement the face authentication, and updates the encryption key information and the target biometric information. On the other hand, in a case where the quality of the face image is lower than the predetermined quality, the information updating unit 117 determines that the face authentication fails because the quality of the face image is low and does not update the encryption key information and the target biometric information.

In the present example embodiment, the information updating unit 117 determines whether to update the encryption key information and the target biometric information, according to the quality of the face image acquired by the quality acquisition unit 118. In other words, in a case where the verification score is low, the information updating unit 117 determines whether to update the encryption key information and the target biometric information, according to a factor of the low verification score. In the present example embodiment, since it is determined whether to update the encryption key information and the target biometric information, according to the factor of the low verification score, it is possible to update the encryption key information and the target biometric information at a more appropriate timing. Other effects are similar to the effects described in the first example embodiment.

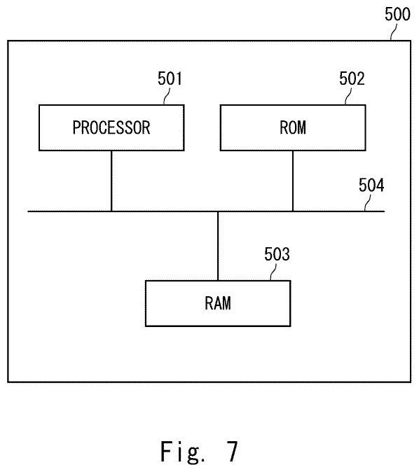

Next, a hardware configuration of the authentication device 110 will be described. FIG. 7 illustrates an example of a hardware configuration of an electronic device that can be used in the authentication device 110. An electronic device 500 includes a processor (Central Processing Unit (CPU)) 501, a Read Only Memory (ROM) 502, and a Random Access Memory (RAM) 503. In the electronic device 500, the processor 501, the ROM 502, and the RAM 503 are connected to each other via a bus 504. Although not illustrated, the authentication device 110 may include other circuits such as a peripheral circuit, a communication circuit, or an interface circuit.

The ROM 502 is a nonvolatile storage device. For example, a semiconductor storage device such as a flash memory having a relatively small capacity is used for the ROM 502. The ROM 502 stores a program executed by the processor 501.

The program described above includes commands (or software codes) for causing a computer to perform one or more functions described in the example embodiments in a case where the program is read by the computer. The program may be stored in a non-transitory computer-readable medium or in a tangible storage medium. As an example and not by way of limitation, the computer-readable medium or the tangible storage medium includes a RAM, a ROM, a flash memory, an SSD or any other memory technology, a Compact Disc (CD), a Digital Versatile Disc (DVD), a Blu-ray® disk or any other optical disk storage, a magnetic cassette, a magnetic tape, a magnetic disk storage or any other magnetic storage device. The program may be transmitted on a transitory computer-readable medium or a communication medium. As an example and not by way of limitation, the transitory computer-readable medium or communication medium includes electrical, optical, acoustic, or other forms of propagated signals.

The RAM 503 is a volatile storage device. As the RAM 503, various types of semiconductor memory devices such as a Dynamic Random Access Memory (DRAM) or a Static Random Access Memory (SRAM) are used. The RAM 503 can be used as an internal buffer for transitorily storing data and the like.

The processor 501 loads the program stored in the ROM 502 on the RAM 503, and executes the program. The function of each unit in the authentication device 110 can be achieved by the CPU 501 executing the program.

In the above example embodiment, the authentication device 110 is not necessarily configured as a single device. The authentication device 110 may be configured using a plurality of physically separated devices. For example, the authentication device 110 may be separated into a device including the image acquisition unit 111, the feature extraction unit 112, the encryption unit 113, and the authentication unit 114 and an information updating device including the comparison unit 116 and the information updating unit 117.

In addition, in a case where the authentication device 110 is used for the vehicle interior entry, the authentication device 110 does not necessarily have all the functions mounted on the vehicle. For example, a part of the functions of the authentication device 110 may be mounted on the vehicle, and the rest may be disposed outside the vehicle. Alternatively, each unit of the authentication device 110 may be disposed outside the vehicle. In that case, the authentication device 110 may acquire the camera image of the camera 130 via a wireless communication network. In addition, the authentication device 110 may transmit the authentication result to the vehicle via the wireless communication network.

While the present disclosure has been particularly shown and described with reference to example embodiments thereof, the present disclosure is not limited to these example embodiments. The present disclosure also includes changes or modifications made to the above example embodiments without departing from the spirit and scope of the present disclosure as defined by the claims.

For example, some or all of the above-described example embodiments may be described as the following Supplementary Notes, but the present disclosure is not limited to the following Supplementary Notes.

### Supplementary Note 1

An information updating device including:
a comparison unit configured to compare a verification score indicating a similarity degree between query biometric information and target biometric information, calculated in authentication implemented by verifying the query biometric information generated by encrypting biometric information of a user using encryption key information against the target biometric information encrypted using the encryption key information, with a first threshold; and
an information updating unit configured to update the encryption key information, in a case where the verification score is smaller than the first threshold and update the target biometric information using the updated

### Supplementary Note 2

The information updating device according to supplementary note 1, in which
it is determined that authentication of the user is successful in a case where the verification score is equal to or more than a second threshold and fails in a case where the verification score is less than the second threshold, and
the first threshold is equal to the second threshold.

### Supplementary Note 3

The information updating device according to supplementary note 2, in which the information updating unit refers to a history of the verification score calculated in a plurality of past authentications and updates the encryption key information, in a case where the number of times that the verification score is determined to be smaller than the first threshold is equal to or more than a predetermined number of times and the verification score tends to increase in the plurality of past authentication and updates the target biometric information using the updated encryption key information.

### Supplementary Note 4

The information updating device according to supplementary note 1, in which
it is determined that authentication of the user is successful in a case where the verification score is equal to or more than a second threshold and fails in a case where the verification score is less than the second threshold, and
the first threshold is smaller than the second threshold.

### Supplementary Note 5

The information updating device according to any one of supplementary notes 1 to 4, further including:
a quality acquisition unit configured to acquire quality of the biometric information of the user,
in which the information updating unit updates the encryption key information, in a case where the acquired quality of the biometric information of the user is equal to or higher than predetermined quality and the verification score is smaller than the first threshold and updates the target biometric information using the updated encryption key information.

### Supplementary Note 6

An authentication device including:
a biometric information acquisition unit configured to acquire biometric information of a user;
an encryption unit configured to encrypt the acquired biometric information using encryption key information and generate query biometric information;
an authentication unit configured to verify the query biometric information against target biometric information encrypted using the encryption key information and authenticate the user, based on a verification score indicating a similarity degree between the query biometric information and the target biometric information;
a comparison unit configured to compare the verification score with a first threshold; and
an information updating unit configured to update the encryption key information, in a case where the verification score is smaller than the first threshold and update the target biometric information using the updated encryption key information.

### Supplementary Note 7

The authentication device according to supplementary note 6, in which
the authentication unit determines that authentication is successful in a case where the verification score is equal to or more than a second threshold and determines that the authentication fails in a case where the verification score is less than the second threshold, and
the first threshold is equal to the second threshold.

### Supplementary Note 8

The authentication device according to supplementary note 6, in which
the authentication unit determines that authentication is successful in a case where the verification score is equal to or more than a second threshold and determines that the authentication fails in a case where the verification score is less than the second threshold, and
the first threshold is smaller than the second threshold.

### Supplementary Note 9

An information updating method including:
comparing a verification score indicating a similarity degree between query biometric information and target biometric information, calculated in authentication implemented by verifying the query biometric information generated by encrypting biometric information of a user using encryption key information against the target biometric information encrypted using the encryption key information, with a predetermined threshold; and
updating the encryption key information, in a case where the verification score is smaller than the predetermined threshold and updating the target biometric information using the updated encryption key information.

### Supplementary Note 10

An authentication method including:
acquiring biometric information of a user;
encrypting the acquired biometric information using encryption key information and generating query biometric information;
verifying the query biometric information against target biometric information encrypted using the encryption key information and authenticating the user, based on a verification score indicating a similarity degree between the query biometric information and the target biometric information;
comparing the verification score with a predetermined threshold; and
updating the encryption key information, in a case where the verification score is smaller than the predetermined threshold and updating the target biometric information using the updated encryption key information.

### Supplementary Note 11

A non-transitory computer-readable medium storing a program for causing a processor to execute processing including:
comparing a verification score indicating a similarity degree between query biometric information and target biometric information, calculated in authentication implemented by verifying the query biometric information generated by encrypting biometric information of a user using encryption key information against the target biometric information encrypted using the encryption key information, with a predetermined threshold; and
updating the encryption key information, in a case where the verification score is smaller than the predetermined threshold and updating the target biometric information using the updated encryption key information.

### Supplementary Note 12

A non-transitory computer-readable medium storing a program for causing a processor to execute processing including:
acquiring biometric information of a user;
encrypting the acquired biometric information using encryption key information and generating query biometric information;
verifying the query biometric information against target biometric information encrypted using the encryption key information and authenticating the user, based on a verification score indicating a similarity degree between the query biometric information and the target biometric information;
comparing the verification score with a predetermined threshold; and
updating the encryption key information, in a case where the verification score is smaller than the predetermined threshold and updating the target biometric information using the updated encryption key information.

### REFERENCE SIGNS LIST

10 authentication device
11 biometric information acquisition unit
12 encryption unit
13 authentication unit
15 comparison unit
16 information updating unit
20 information updating device
110 authentication device
111 image acquisition unit
112 feature extraction unit
113 encryption unit
114 authentication unit
115 face information DB
116 comparison unit
117 information updating unit
118 quality acquisition unit
130 camera
500 electronic device
501 processor
502 ROM
503 RAM
504 bus

What is claimed is:

1. An information updating device comprising:
at least one memory storing instructions; and
at least one processor configured to execute the instructions to:
compare a verification score indicating a similarity degree between query biometric information and target biometric information, calculated in authentication implemented by verifying the query biometric information generated by encrypting biometric information of a user using encryption key information against the target biometric information encrypted using the encryption key information, with a first threshold; and
update the encryption key information, in a case where the verification score is smaller than the first threshold and update the target biometric information using the updated encryption key information.

2. The information updating device according to claim 1, wherein
it is determined that authentication of the user is successful in a case where the verification score is equal to or more than a second threshold and fails in a case where the verification score is less than the second threshold, and
the first threshold is equal to the second threshold.

3. The information updating device according to claim 2, wherein the at least one processor is configured to execute the instructions to refer to a history of the verification score calculated in a plurality of past authentications and update the encryption key information, in a case where a number of times that the verification score is determined to be smaller than the first threshold is equal to or more than a predetermined number of times and the verification score tends to increase in the plurality of past authentications and update the target biometric information using the updated encryption key information.

4. The information updating device according to claim 1, wherein
it is determined that authentication of the user is successful in a case where the verification score is equal to or more than a second threshold and fails in a case where the verification score is less than the second threshold, and
the first threshold is smaller than the second threshold.

5. The information updating device according to claim 1, wherein the at least one processor is configured to execute the instructions to:
acquire quality of the biometric information of the user, and
update the encryption key information, in a case where the acquired quality of the biometric information of the user is equal to or higher than predetermined quality and the verification score is smaller than the first threshold and update the target biometric information using the updated encryption key information.

6. An authentication device comprising:
at least one memory storing instructions; and
at least one processor configured to execute the instructions to:
acquire biometric information of a user;
encrypt the acquired biometric information using encryption key information and generate query biometric information;
verify the query biometric information against target biometric information encrypted using the encryption key information and authenticate the user, based on a verification score indicating a similarity degree between the query biometric information and the target biometric information;
compare the verification score with a first threshold; and
update the encryption key information, in a case where the verification score is smaller than the first threshold and update the target biometric information using the updated encryption key information.

7. The authentication device according to claim 6, wherein
the at least one processor is configured to execute the instructions to determine that authentication is successful in a case where the verification score is equal to or more than a second threshold and determines that the authentication fails in a case where the verification score is less than the second threshold, and
the first threshold is equal to the second threshold.

8. The authentication device according to claim 6, wherein
the at least one processor is configured to execute the instructions to determine that authentication is successful in a case where the verification score is equal to or more than a second threshold and determines that the authentication fails in a case where the verification score is less than the second threshold, and
the first threshold is smaller than the second threshold.

9. An information updating method comprising:
comparing a verification score indicating a similarity degree between query biometric information and target biometric information, calculated in authentication implemented by verifying the query biometric information generated by encrypting biometric information of a user using encryption key information against the target biometric information encrypted using the encryption key information, with a predetermined threshold; and
updating the encryption key information, in a case where the verification score is smaller than the predetermined threshold and updating the target biometric information using the updated encryption key information.

10.-12. (canceled)
